(19) United States
(12) Patent Application Publication
(10) Pub. No.: US 2014/0267616 A1
(43) Pub. Date: Sep. 18, 2014

(54) VARIABLE RESOLUTION DEPTH REPRESENTATION

(71) Applicant: Scott A. Krig, Folsom, CA (US)

(72) Inventor: Scott A. Krig, Folsom, CA (US)

(21) Appl. No.: 13/844,295

(22) Filed: Mar. 15, 2013

(51) Int. Cl. H04N 13/00

(52) U.S. Cl. CPC H04N 13/0022
USPC 348/46; 382/154

(57) ABSTRACT

An apparatus, image capture device, computing device, computer readable medium are described herein. The apparatus includes logic to determine a depth indicator. The apparatus also includes logic to vary a depth information of an image based on the depth indicator, and logic to generate the variable resolution depth representation. A depth indicator may be lighting, texture, edges, contours, colors, motion, time, or any combination thereof.

### TECHNICAL FIELD

The present invention relates generally to depth representations. More specifically, the present invention relates to standardized depth representations with variable resolutions.

### BACKGROUND ART

During image capture, there are various techniques used to capture depth information associated with the image information. The depth information is typically used to produce a representation of the depth contained within the image. For example, a point cloud, a depth map, or a three dimensional (3D) polygonal mesh that may be used to indicate at the depth of shape of 3D objects within the image. Depth information can be also be derived from two dimensional (2D) images using stereo pairs or multiview stereo reconstruction methods, and also derived from a wide range of direct depth sensing methods including structured light, time of flight sensors, and many other methods.

### BRIEF DESCRIPTION OF THE DRAWINGS

FIG. 1 is a block diagram of a computing device that may be used to produce variable resolution depth representations;

FIG. 2 is an illustration of a variable resolution depth map and another variable resolution depth map based on variable bit depths;

FIG. 3 is an illustration of a variable resolution depth map and the resulting image based on variable spatial resolution;

FIG. 4 is a set of images developed from variable resolution depth maps;

FIG. 5 is a process flow diagram of a method to produce a variable resolution depth map;

FIG. 6 is a block diagram of an exemplary system for generating a variable resolution depth map;

FIG. 7 is a schematic of a small form factor device in which the system 600 of FIG. 6 may be embodied; and

FIG. 8 is a block diagram showing tangible, non-transitory computer-readable media that stores code for variable resolution depth representations.

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Each depth representation is a homogenous representation of depth. The depth is either densely generated for each pixel, or sparsely generated at specific pixels surrounded by known features. Thus, current depth maps do not model the human visual system or optimize the depth mapping process, providing only a homogenous or a constant resolution.

Embodiments provided herein enable variable resolution depth representations. In some embodiments, the depth representation may be tuned based on the use of the depth map or an area of interest within the depth map. In some embodiments, alternative optimized depth map representations are generated. For ease of description, the techniques are described using pixels. However, any unit of image data can be used, such as a voxel, point cloud, or 3D mesh as used in computer graphics. The variable resolution depth representation may include a set of depth information captured at heterogeneous resolutions throughout the entire depth representation, as well as depth information captured from one or more depth sensors working together. The resulting depth information may take the form of dense evenly spaced points, or sparse unevenly spaced points, or lines of an image, or an entire 2D image array, depending on the chosen methods.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 that may be used to produce variable resolution depth representations. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The instructions that are executed by the CPU 102 may be used to implement shared virtual memory.

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100. In some embodiments, the GPU 108 includes a number of graphics engines (not shown), wherein each graphics engine is configured to perform specific graphics tasks, or to execute specific types of workloads. For example, the GPU 108 may include an engine that produces variable resolution depth maps. The particular resolution of the depth map may be based on an application.

The memory device 104 can include random access memory (RAM), read only memory (ROM), flash memory, or any other suitable memory systems. For example, the memory device 104 may include dynamic random access memory (DRAM). The memory device 104 includes drivers 110. The drivers 110 are configured to execute the instructions for the operation of various components within the computing device 100. The device driver 110 may be software, an application program, application code, or the like.

The computing device 100 includes an image capture device 112. In some embodiments, the image capture device 112 is a camera, stereoscopic camera, infrared sensor, or the like. The image capture device 112 is used to capture image information. The image capture mechanism may include sensors 114 such as a depth sensor, an image sensor, an infrared sensor, an X-Ray photon counting sensor or any combination thereof. The image sensors may include charge-coupled device (CCD) image sensors, complementary metal-oxide-semiconductor (CMOS) image sensors, system on chip (SOC) image sensors, image sensors with photosensitive thin film transistors, or any combination thereof. In some embodiments, a sensor 114 is a depth sensor 114. The depth sensor 114 may be used to capture the depth information associated with image information. In some embodiments, a driver 110 may be used to operate a sensor within the image capture device 112, such as a depth sensor. The depth sensor may produce a variable resolution depth map by analyzing variations between the pixels and capturing the pixels according to a desired resolution.

The CPU 102 may be connected through the bus 106 to an input/output (I/O) device interface 116 configured to connect the computing device 100 to one or more I/O devices 118. The I/O devices 118 may include, for example, a keyboard and a pointing device, wherein the pointing device may include a touchpad or a touchscreen, among others. The I/O devices 118 may be built-in components of the computing device 100, or may be devices that are externally connected to the computing device 100.

The CPU 102 may also be linked through the bus 106 to a display interface 120 configured to connect the computing device 100 to a display device 122. The display device 122 may include a display screen that is a built-in component of the computing device 100. The display device 122 may also include a computer monitor, television, or projector, among others, that is externally connected to the computing device 100.

The computing device also includes a storage device 124. The storage device 124 is a physical memory such as a hard drive, an optical drive, a thumbdrive, an array of drives, or any combinations thereof. The storage device 124 may also include remote storage drives. The storage device 124 includes any number of applications 126 that are configured to run on the computing device 100. The applications 126 may be used to combine the media and graphics, including 3D stereo camera images and 3D graphics for stereo displays. In examples, an application 126 may be used to generate a variable resolution depth map.

The computing device 100 may also include a network interface controller (NIC) 128 may be configured to connect the computing device 100 through the bus 106 to a network 130. The network 130 may be a wide area network (WAN), local area network (LAN), or the Internet, among others.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

The variable resolution depth representation may be in various formats, such as a 3D point cloud, polygonal mesh, or a two dimensional (2D) depth Z-array. For purposes of description, a depth map is used to describe features for a variable resolution depth representation. However, any type of depth representation can be used as described herein. Additionally, for purposes of description, pixels are used to describe some units of the representations. However, any type of units can be used, such as volumetric pixels (voxels).

The resolution of the depth representation may vary in a manner similar to the human eye. The human visual system is highly optimized to capture increasing detail where needed by increasing effective resolution within a varying radial concentration of photo receptors and ganglia cells near the center of the retina and decreasing these cells exponentially further away from center which optimizes resolution and depth perception by increasing detail where needed and reducing detail elsewhere.

The retina includes a small region called the foveola, which may provide the highest depth resolution at the target location. The eye then can make further rapid saccadic movements to dither around the target location and add additional resolution to the target location. Thus, dithering enables data from pixels surrounding the focal point to be considered when calculating the resolution of the focal point. The fovea region is an area that surrounds the foveola that also adds detail to human vision, but at a lower resolution when compared to the foveola region. A parafovea region provides less detail than the foveola region, and the perifovea region provides less resolution that the parafovea region. Thus, the perifovea region provides the least detail within the human visual system.

Variable depth representations can be arranged in a manner similar to the human visual system. In some embodiments, the sensor can be used to reduce the size of pixels near the center of the sensor. The location of the area where the pixels are reduced may also be variable according to commands received by the sensor. The depth map may also include several depth layers. A depth layer is a region of the depth map with a specific depth resolution. The depth layers are similar to the regions of the human visual system. For example, a fovea layer may be the focus of the depth map and the area with the highest resolution. A foveola layer may surround the fovea layer with less resolution than the fovea layer. A parafovea layer may surround the foveola layer with less resolution than the foveola layer. Additionally, the perifoveola layer may surround the parafoveola layer with less resolution than the parafoveola layer. In some embodiments, the parafoveola layer may be referred to as the background layer of the depth representation. Further, the background layer may be a homogeneous area of depth map containing all depth info past a specific distance. The background layer may be set to the lowest resolution within the depth representation. Although four layers are described here, the variable resolution depth representation may contain any number of layers.

The depth information indicated by the variable resolution depth representation can be varied using several techniques. One technique to vary the variable resolution depth representation is using variable bit depths. The bit depth for each pixel refers to the level of bit precision for each pixel. By varying the bit depth of each pixel, the amount of information stored for each pixel can also be varied. Pixels with smaller bit depths to store less information regarding the pixel, which results in less resolution for the pixel when rendered. Another technique to vary the variable resolution depth representation is using variable spatial resolution. By varying the spatial resolution, the size of each pixel or voxel is varied. The varying sizes results in less depth information being stored when the larger pixel regions are processed together as regions, and more depth information being retained when the smaller pixels are processed independently. In some embodiments, variable bit depth, variable spatial resolution, a reduction in pixel size, or any combination thereof can be used to vary the resolution of regions within a depth representation.

FIG. 2 is an illustration of a variable resolution depth map 202 and another variable resolution depth map 204 based on variable bit depths. Variable bit depths may also be referred to as variable bit precision. Both the variable resolution depth map 202 and the variable resolution depth map 204 have a specific bit depth, as indicated by the numerals inside each square of the depth map 202 and the depth map 204. For purposes of description, the depth map 202 and the depth map 204 are divided into a number of squares, with each square representing a pixel of the depth map. However, a depth map can contain any number of pixels.

The depth map 202 has regions that are square in shape, while the depth map 204 has regions that are substantially circular in shape. The regions of the depth map 204 are substantially circular, as the squares shown do not completely conform to a circular shape. Any shape can be used to define the various regions in the variable resolution depth representation such as circles, rectangles, octagons, polygons or curved spline shapes. The layer at reference number 206 in each of the depth map 202 and the depth map 204 has a bit depth of 16 bits, where 16 bits of information is stored for each pixel. By storing 16 bits of information for each pixel, a maximum of 65,536 different gradations in color can be stored for each pixel depending on the binary number representation. The layer at reference number 208 of the depth map 202 and the depth map 204 has a bit depth of 8 bits, where 8 bits of information is stored for each pixel which results in a maximum of 256 different gradations in color for each pixel. Finally, the layer at reference number 210 has a bit depth of 4 bits, where 4 bits of information is stored for each pixel which results in a maximum of 16 different gradations in color for each pixel.

FIG. 3 is an illustration of a variable resolution depth map 302 and the resulting image 304 based on variable spatial resolution. In some embodiments, the depth map 302 may use a voxel pyramid representation of depth. The pyramid representations may be used to detect features of an image, such as a face or eyes. The pyramid octave resolution can vary among the layers of the depth map. The layer at reference number 306 has a coarse one-fourth pyramid octave resolution, which results in four voxels being processed as a unit. The layer at reference number 308 has a finer one-half pyramid octave resolution, which results in two voxels being processed as a unit. The center layer at reference number 310 has the highest pyramid octave resolution with a one-to-one pyramid octave resolution, where one voxel is processed as a unit. The resulting image 304 has the highest resolution at the center of the image, near the eyes of the image. In some embodiments, the depth information may be stored as variable resolution layers in a structured file format. Moreover, in some embodiments a layered variable spatial resolution may be used create a variable resolution depth representation. In layered variable spatial resolution, an image pyramid is generated and then used as a replicated background for higher resolution regions to be overlayed. The smallest region of the image pyramid could be replicated as the background to fill the area of the image in order to cover the entire field of view.

By using a high resolution in only a portion of the depth representation, the size of the depth map may be reduced since less information is stored for lower resolution areas. Further, power consumption is reduced when a smaller file using variable depth representations are processed. In some embodiments, the size of pixels may be decreased at the focal point of the depth map. The size of the pixels may be reduced in a manner that increases the effective resolution of the layer of the representation that includes the focal point. A reduction in pixel size is similar to the retinal pattern of the human visual system. To reduce the size of the pixels, the depth of a sensor cell receptor can be increased so that additional photons can be collected at the focal point in the image. In some embodiments, a depth sensing module may increase effective resolution by a design which is built like the human visual system, where increasing photo receptors implemented as photo diodes are implemented in a pattern which resembles the retina patterns discussed above. In some embodiments, layered depth precision and variable depth region shape can be used to reduce the size of the depth map.

FIG. 4 is a set of images 400 developed from variable resolution depth maps. The images 400 include several regions with varying levels of resolution. In some embodiments, variable bit depth, variable spatial resolution, a reduction in pixel size, or any combination thereof, can be automatically tuned based on depth indicators. As used herein a depth indicator is a feature of an image that can be used to distinguish between areas of varying depth resolution. Accordingly, a depth indicator can be lighting, texture, edges, contours, colors, motion, or time. However, a depth indicator can be any feature of an image that can be used to distinguish between areas of varying depth resolution.

Automatically tuned resolution regions are areas of the depth map which are tuned to a spatial resolution, bit depth, pixel size, or any combination thereof using a depth indicator. Any layer of the depth map can be overlayed with tuned resolution regions. The tuned resolution regions can be based on commands to the image sensor to reduce depth where depth indicators are at a particular value. For example, when texture is low the depth resolution may be low, and where texture is high the depth resolution may also be high. The image sensor can automatically tune the depth image, and the resulting variable resolutions stored in the depth map.

The images 400 use texture as a depth indicator to vary the depth resolution. In some embodiments, the depth sensor is used to automatically detect regions of low texture using texture-based depth tuning. Regions of low texture may be detected by the depth sensor. In some embodiments, the regions of low texture are detected using texture analysis. In some embodiments, the regions of low texture are detected by the pixels meeting some threshold that indicates texture. Further, variable bit depth and variable spatial resolution may be used to reduce the depth resolution in regions of low texture as found by the depth sensor. Similarly, variable bit precision and variable spatial resolution may be used to increase the depth resolution in areas of high texture. The particular indicator used to vary the resolution in a depth representation may be based on the particular application for the depth map. Moreover, using depth indicators enables depth information based on the indicator to be stored while reducing the size of the depth representation as well as the power used to process the depth representation.

When motion is used as a depth indicator, a dynamic frame rate is used to enable the depth sensor to determine the frame rate based on the scene motion. For example, if there is no scene movement, there is no need to calculate a new depth map. As a result, for scene movement below a predetermined threshold, a lower frame rate can be used. Similarly, for scene movement above a predetermined threshold, a higher frame rate can be used. In some embodiments, a sensor can detect frame motion using pixel neighborhood comparisons and applying thresholds to pixel-motion from frame to frame. Frame rate adjustments allow for depth maps to be created at chosen or dynamically calculated intervals, including regular intervals and up/down ramps. Moreover, the frame rate can be variable based on the depth layer. For example, the depth map can be updated at a rate of 60 frames per second (FPS) for a high resolution depth layer while updating the depth map for a lower resolution depth layer at 30 FPS.

In addition to automatic tuning of the depth resolution using depth indicators, the depth resolution may be tuned based on a command to the sensor that a particular focal point within the image should be the point of highest or lowest resolution. Additionally, the depth resolution may be tuned based on a command to the sensor that a particular object within the image should be the point of highest or lowest resolution. In examples, the focal point could be the center of the image. The sensor could then designate the center of the image as the fovea layer, and then designate the foveola layer, perifoveola layer, and parafoveola layer based on further commands to the sensor. The other layers may also be designated through settings of the sensor already in place. Moreover, each layer is not always present in the variable depth map representation. For example, when a focal point is tracked, the variable depth map representation may include a fovea layer and a perifoveola layer.

The result of varying the resolution among different regions of the depth representation is a depth representation composed of layers of variable resolution depth information. In some embodiments, the variable resolution is automatically created by the sensor. A driver may be used to operate the sensor in a manner that varies the resolution of the depth representation. The sensor drivers can be modified such that when a sensor is processing pixels that can be associated with a particular depth indicator, the sensor automatically modifies the bit depth or spatial resolution of the pixels. For example, a CMOS sensor typically processes image data in a line-by-line fashion. When the sensor processes pixels with a certain lighting value range where a low resolution is desired, the sensor may automatically reduce the bit depth or spatial resolution for pixels within that lighting value range. In this manner, the sensor can be used to produce the variable resolution depth map.

In some embodiments, a command protocol may be used to obtain variable resolution depth maps using the sensor. In some embodiments, an image capture device may communicate with the computing device using commands within the protocol to indicate the capabilities of the image capture mechanism. For example, the image capture mechanism can use commands to indicate the levels of resolution provided by the image capture mechanism, the depth indicators supported by the image capture mechanism, and other information for operation using variable depth representations. The command protocol may also be used to designate the size of each depth layer.

In some embodiments, the variable resolution depth representation can be stored using a standard file format. Within the file containing the variable resolution depth representation, header information may be stored that indicates the size of each depth layer, the depth indicators used, the resolution of each layer, the bit depth, the spatial resolution, and the pixel size. In this manner, the variable resolution depth representation can be portable across multiple computing systems. Moreover, the standardized variable resolution depth representation file can enable access to the image information by layer. For example, an application can access the lowest resolution portion of the image for processing by accessing the header information in the standardized variable resolution depth representation file. In some embodiments, the variable resolution depth map can be standardized as a file format, as well as features in a depth sensing module.

FIG. 5 is a process flow diagram of a method to produce a variable resolution depth map. At block 502, a depth indicator is determined. As discussed above, a depth indicator can be lighting, texture, edges, contours, colors, motion, or time. Further, the depth indicator can be determined by a sensor, or the depth indicator can be sent to the sensor using a command protocol.

At block 504, the depth information is varied based on the depth indicator. In some embodiments, the depth information can be varied using variable bit depth, variable spatial resolution, a reduction in pixel size, or any combination thereof. The variation in depth information results in one or more depth layers within the variable resolution depth map. In some embodiments, layered variable spatial resolution can be used to vary the depth information by replicating a portion of a depth layer in order to fill remaining space at a particular depth layer. Additionally, the depth information can be varied using automatically tuned resolution regions. At block 506, the variable resolution depth representation is generated based on the varied depth information. The variable resolution depth representation may be stored in a standardized file format with standardized header information.

Using the presently described techniques, depth representation accuracy can be increased. Variable resolution depth maps provide accuracy where needed within the depth representation, which enables for intensive algorithms to be used where accuracy is needed, and less intensive algorithms to be used where accuracy is not needed. For example, stereo depth matching algorithms can be optimized in certain regions to provide sub-pixel accuracy is some regions, pixel accuracy in other regions, and pixel group accuracy in low resolution regions.

The depth resolutions can be provided in a manner that matches human visual system. By computing depth map resolution modeled after the human eye, appropriately defined for accuracy only where needed, performance is increased, and power is reduced, as the entire depth map is not high resolution. Furthermore, by adding variable resolution to the depth map, parts of the depth image that require higher resolution may have it, and parts that require lower resolution may have that as well, resulting in smaller depth maps which consume less memory. When motion is monitored as a depth indicator, the resolution can be selectively increased in areas of high motion, and decreased in areas of low motion. Also by monitoring the texture as a depth indicator, accuracy of the depth map can be increased in high texture areas and decreased in low texture areas. A field of view of the depth map can also be limited to areas that have changed, decreasing memory bandwidth.

FIG. 6 is a block diagram of an exemplary system 600 for generating a variable resolution depth map. Like numbered items are as described with respect to FIGS. 1. In some embodiments, the system 600 is a media system. In addition, the system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, or the like.

In various embodiments, the system 600 comprises a platform 602 coupled to a display 604. The platform 602 may receive content from a content device, such as content services device(s) 606 or content delivery device(s) 608, or other similar content sources. A navigation controller 610 including one or more navigation features may be used to interact with, for example, the platform 602 and/or the display 604. Each of these components is described in more detail below.

The platform 602 may include any combination of a chipset 612, a central processing unit (CPU) 102, a memory device 104, a storage device 124, a graphics subsystem 614, applications 126, and a radio 616. The chipset 612 may provide intercommunication among the CPU 102, the memory device 104, the storage device 124, the graphics subsystem 614, the applications 126, and the radio 614. For example, the chipset 612 may include a storage adapter (not shown) capable of providing intercommunication with the storage device 124.

The CPU 102 may be implemented as Complex Instruction Set Computer (CISC) or Reduced Instruction Set Computer (RISC) processors, x86 instruction set compatible processors, multi-core, or any other microprocessor or central processing unit (CPU). In some embodiments, the CPU 102 includes dual-core processor(s), dual-core mobile processor(s), or the like.

The memory device 104 may be implemented as a volatile memory device such as, but not limited to, a Random Access Memory (RAM), Dynamic Random Access Memory (DRAM), or Static RAM (SRAM). The storage device 124 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some embodiments, the storage device 124 includes technology to increase the storage performance enhanced protection for valuable digital media when multiple hard drives are included, for example.

The graphics subsystem 614 may perform processing of images such as still or video for display. The graphics subsystem 614 may include a graphics processing unit (GPU), such as the GPU 108, or a visual processing unit (VPU), for example. An analog or digital interface may be used to communicatively couple the graphics subsystem 614 and the display 604. For example, the interface may be any of a High-Definition Multimedia Interface, DisplayPort, wireless HDMI, and/or wireless HD compliant techniques. The graphics subsystem 614 may be integrated into the CPU 102 or the chipset 612. Alternatively, the graphics subsystem 614 may be a stand-alone card communicatively coupled to the chipset 612.

The graphics and/or video processing techniques described herein may be implemented in various hardware architectures. For example, graphics and/or video functionality may be integrated within the chipset 612. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 616 may include one or more radios capable of transmitting and receiving signals using various suitable wireless communications techniques. Such techniques may involve communications across one or more wireless networks. Exemplary wireless networks include wireless local area networks (WLANs), wireless personal area networks (WPANs), wireless metropolitan area network (WMANs), cellular networks, satellite networks, or the like. In communicating across such networks, the radio 616 may operate in accordance with one or more applicable standards in any version.

The display 604 may include any television type monitor or display. For example, the display 604 may include a computer display screen, touch screen display, video monitor, television, or the like. The display 604 may be digital and/or analog. In some embodiments, the display 604 is a holographic display. Also, the display 604 may be a transparent surface that may receive a visual projection. Such projections may convey various forms of information, images, objects, or the like. For example, such projections may be a visual overlay for a mobile augmented reality (MAR) application. Under the control of one or more applications 126, the platform 602 may display a user interface 618 on the display 604.

The content services device(s) 606 may be hosted by any national, international, or independent service and, thus, may be accessible to the platform 602 via the Internet, for example. The content services device(s) 606 may be coupled to the platform 602 and/or to the display 604. The platform 602 and/or the content services device(s) 606 may be coupled to a network 130 to communicate (e.g., send and/or receive) media information to and from the network 130. The content delivery device(s) 608 also may be coupled to the platform 602 and/or to the display 604.

The content services device(s) 606 may include a cable television box, personal computer, network, telephone, or Internet-enabled device capable of delivering digital information. In addition, the content services device(s) 606 may include any other similar devices capable of unidirectionally or bidirectionally communicating content between content providers and the platform 602 or the display 604, via the network 130 or directly. It will be appreciated that the content may be communicated unidirectionally and/or bidirectionally to and from any one of the components in the system 600 and a content provider via the network 130. Examples of content may include any media information including, for example, video, music, medical and gaming information, and so forth.

The content services device(s) 606 may receive content such as cable television programming including media information, digital information, or other content. Examples of content providers may include any cable or satellite television or radio or Internet content providers, among others.

In some embodiments, the platform 602 receives control signals from the navigation controller 610, which includes one or more navigation features. The navigation features of the navigation controller 610 may be used to interact with the user interface 618, for example. The navigation controller 610 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures. Physical gestures include but are not limited to facial expressions, facial movements, movement of various limbs, body movements, body language or any combination thereof. Such physical gestures can be recognized and translated into commands or instructions.

Movements of the navigation features of the navigation controller 610 may be echoed on the display 604 by movements of a pointer, cursor, focus ring, or other visual indicators displayed on the display 604. For example, under the control of the applications 126, the navigation features located on the navigation controller 610 may be mapped to virtual navigation features displayed on the user interface 618. In some embodiments, the navigation controller 610 may not be a separate component but, rather, may be integrated into the platform 602 and/or the display 604.

The system 600 may include drivers (not shown) that include technology to enable users to instantly turn on and off the platform 602 with the touch of a button after initial boot-up, when enabled, for example. Program logic may allow the platform 602 to stream content to media adaptors or other content services device(s) 606 or content delivery device(s) 608 when the platform is turned “off.” In addition, the chipset 612 may include hardware and/or software support for 5.1 surround sound audio and/or high definition 7.1 surround sound audio, for example. The drivers may include a graphics driver for integrated graphics platforms. In some embodiments, the graphics driver includes a peripheral component interconnect express (PCIe) graphics card.

In various embodiments, any one or more of the components shown in the system 600 may be integrated. For example, the platform 602 and the content services device(s) 606 may be integrated; the platform 602 and the content delivery device(s) 608 may be integrated; or the platform 602, the content services device(s) 606, and the content delivery device(s) 608 may be integrated. In some embodiments, the platform 602 and the display 604 are an integrated unit. The display 604 and the content service device(s) 606 may be integrated, or the display 604 and the content delivery device(s) 608 may be integrated, for example.

The system 600 may be implemented as a wireless system or a wired system. When implemented as a wireless system, the system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum. When implemented as a wired system, the system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, or the like. Examples of wired communications media may include a wire, cable, metal leads, printed circuit board (PCB), backplane, switch fabric, semiconductor material, twisted-pair wire, co-axial cable, fiber optics, or the like.

The platform 602 may establish one or more logical or physical channels to communicate information. The information may include media information and control information. Media information may refer to any data representing content meant for a user. Examples of content may include, for example, data from a voice conversation, videoconference, streaming video, electronic mail (email) message, voice mail message, alphanumeric symbols, graphics, image, video, text, and the like. Data from a voice conversation may be, for example, speech information, silence periods, background noise, comfort noise, tones, and the like. Control information may refer to any data representing commands, instructions or control words meant for an automated system. For example, control information may be used to route media information through a system, or instruct a node to process the media information in a predetermined manner. The embodiments, however, are not limited to the elements or the context shown or described in FIG. 6.

FIG. 7 is a schematic of a small form factor device 700 in which the system 600 of FIG. 6 may be embodied. Like numbered items are as described with respect to FIG. 6. In some embodiments, for example, the device 700 is implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and the like.

An example of a mobile computing device may also include a computer that is arranged to be worn by a person, such as a wrist computer, finger computer, ring computer, eyeglass computer, belt-clip computer, arm-band computer, shoe computer, clothing computer, or any other suitable type of wearable computer. For example, the mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well.

As shown in FIG. 7, the device 700 may include a housing 702, a display 704, an input/output (I/O) device 706, and an antenna 708. The device 700 may also include navigation features 710. The display 704 may include any suitable display unit for displaying information appropriate for a mobile computing device. The I/O device 706 may include any suitable I/O device for entering information into a mobile computing device. For example, the I/O device 706 may include an alphanumeric keyboard, a numeric keypad, a touch pad, input keys, buttons, switches, rocker switches, microphones, speakers, a voice recognition device and software, or the like. Information may also be entered into the device 700 by way of microphone. Such information may be digitized by a voice recognition device.

In some embodiments, the small form factor device 700 is a tablet device. In some embodiments, the tablet device includes an image capture mechanism, where the image capture mechanism is a camera, stereoscopic camera, infrared sensor, or the like. The image capture device may be used to capture image information, depth information, or any combination thereof. The tablet device may also include one or more sensors. For example, the sensors may be a depth sensor, an image sensor, an infrared sensor, an X-Ray photon counting sensor or any combination thereof. The image sensors may include charge-coupled device (CCD) image sensors, complementary metal-oxide-semiconductor (CMOS) image sensors, system on chip (SOC) image sensors, image sensors with photosensitive thin film transistors, or any combination thereof. In some embodiments, the small form factor device 700 is a camera.

Furthermore, in some embodiments, the present techniques may be used with displays, such as television panels and computer monitors. Any size display can be used. In some embodiments, a display is used to render images and video that include variable resolution depth representations. Moreover, in some embodiments, the display is a three dimensional display. In some embodiments, the display includes an image capture device to capture images using variable resolution depth representations. In some embodiments, an image device may capture images or video using variable resolution depth representations, and then render the images or video to a user in real time.

Additionally, in embodiments, the computing device 100 or the system 600 may include a print engine. The print engine can send an image to a printing device. The image may include a depth representation as described herein. The printing device can include printers, fax machines, and other printing devices that can print the resulting image using a print object module. In some embodiments, the print engine may send a variable resolution depth representation to the printing device across a network 130 (FIG. 1, FIG. 6). In some embodiments, the printing device includes one or more sensors to vary depth information based on a depth indicator. The printing device may also generate, render, and print the variable resolution depth representation.

FIG. 8 is a block diagram showing tangible, non-transitory computer-readable media 800 that stores code for variable resolution depth representations. The tangible, non-transitory computer-readable media 800 may be accessed by a processor 802 over a computer bus 804. Furthermore, the tangible, non-transitory computer-readable medium 800 may include code configured to direct the processor 802 to perform the methods described herein.

The various software components discussed herein may be stored on one or more tangible, non-transitory computer-readable media 800, as indicated in FIG. 8. For example, an indicator module 806 may be configured to determine a depth indicator. A depth module 808 may be configured to vary depth information of an image based on the depth indicator. A representation module 810 may generate the variable resolution depth representation.

The block diagram of FIG. 8 is not intended to indicate that the tangible, non-transitory computer-readable medium 800 is to include all of the components shown in FIG. 8. Further, the tangible, non-transitory computer-readable medium 800 may include any number of additional components not shown in FIG. 8, depending on the details of the specific implementation.

### Example 1

An apparatus for generating a variable resolution depth representation is described herein. The apparatus includes logic to determine a depth indicator, logic to vary a depth information of an image based on the depth indicator, and logic to generate the variable resolution depth representation.

The depth indicator may be lighting, texture, edges, contours, colors, motion, time, or any combination thereof. Additionally, the depth indicator may be specified by a use of the variable resolution depth representation. Logic to vary a depth information of an image based on the depth indicator may include varying the depth information using variable bit depth, variable spatial resolution, a reduction in pixel size, or any combination thereof. One or more depth layers may be obtained from the varied depth information, wherein each depth layer includes a specific depth resolution. Logic to vary a depth information of an image based on the depth indicator may include using layered variable spatial resolution. The variable resolution depth representation may be stored in a standardized file format with standardized header information. A command protocol may be used to generate the variable resolution depth representation. The apparatus may be a tablet device or a print device. Additionally, the variable resolution depth representation may be used to render an image or video on a display.

### Example 2

An image capture device is described herein. The image capture device includes a sensor, wherein the sensor determines a depth indicator, captures depth information based on the depth indicator, and generates a variable resolution depth representation based on the depth information. The depth indicator may be lighting, texture, edges, contours, colors, motion, time, or any combination thereof. The depth indicator may be determined based on commands received by the sensor using a command protocol. The sensor may vary the depth information using variable bit depth, variable spatial resolution, a reduction in pixel size, or any combination thereof. Additionally, the sensor may generate depth layers from the depth information, wherein each depth layer includes a specific depth resolution. The sensor may generate the variable resolution depth representation in a standardized file format with standardized header information. Further, the sensor may include an interface for a command protocol that is used to generate the variable resolution depth representation. The image capture device may be a camera, stereo camera, time of flight sensor, depth sensor, structured light camera, or any combinations thereof.

### Example 3

A computing device is described herein. The computing device includes a central processing unit (CPU) that is configured to execute stored instructions, and a storage device that stores instructions, the storage device comprising processor executable code. The processor executable code, when executed by the CPU, is configured to determine a depth indicator, vary a depth information of an image based on the depth indicator, and generate the variable resolution depth representation. The depth indicator may be lighting, texture, edges, contours, colors, motion, time, or any combination thereof. Varying a depth information of an image based on the depth indicator may include varying the depth information using variable bit depth, variable spatial resolution, a reduction in pixel size, or any combination thereof. One or more depth layers may be obtained from the varied depth information, wherein each depth layer includes a specific depth resolution.

### Example 4

A tangible, non-transitory, computer-readable medium is described herein. The computer-readable medium includes code to direct a processor to determine a depth indicator, vary a depth information of an image based on the depth indicator, and generate the variable resolution depth representation. The depth indicator may be lighting, texture, edges, contours, colors, motion, time, or any combination thereof. Additionally, the depth indicator may be specified by a use of the variable resolution depth representation by an application. Varying a depth information of an image based on the depth indicator may include varying the depth information using variable bit depth, variable spatial resolution, a reduction in pixel size, or any combination thereof.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus for generating a variable resolution depth representation, comprising:
logic to determine a depth indicator;
logic to vary a depth information of an image based on the depth indicator; and
logic to generate the variable resolution depth representation.

2. The apparatus of claim 1, wherein the depth indicator is lighting, texture, edges, contours, colors, motion, time, or any combination thereof.

3. The apparatus of claim 1, wherein the depth indicator is specified by a use of the variable resolution depth representation.

4. The apparatus of claim 1, wherein logic to vary a depth information of an image based on the depth indicator includes varying the depth information using variable bit depth, variable spatial resolution, a reduction in pixel size, or any combination thereof.

5. The apparatus of claim 1, comprising obtaining one or more depth layers from the varied depth information, wherein each depth layer includes a specific depth resolution.

6. The apparatus of claim 1, wherein logic to vary a depth information of an image based on the depth indicator includes using layered variable spatial resolution.

7. The apparatus of claim 1, wherein the variable resolution depth representation is stored in a standardized file format with standardized header information.

8. The apparatus of claim 1, wherein a command protocol is used to generate the variable resolution depth representation.

9. The apparatus of claim 1, wherein the apparatus is a tablet device.

10. The apparatus of claim 1, wherein the apparatus is a print device.

11. The apparatus of claim 1, further comprising rendering the variable resolution depth representation is used to render an image or video on a display.

12. An image capture device including a sensor, wherein the sensor determines a depth indicator, captures depth information based on the depth indicator, and generates a variable resolution depth representation based on the depth information.

13. The image capture device of claim 12, wherein the depth indicator is lighting, texture, edges, contours, colors, motion, time, or any combination thereof.

14. The image capture device of claim 12, wherein the depth indicator is determined based on commands received by the sensor using a command protocol.

15. The image capture device of claim 12, wherein the sensor varies the depth information using variable bit depth, variable spatial resolution, a reduction in pixel size, or any combination thereof.

16. The image capture device of claim 12, wherein the sensor generates depth layers from the depth information, wherein each depth layer includes a specific depth resolution.

17. The image capture device of claim 12, wherein the sensor generates the variable resolution depth representation in a standardized file format with standardized header information.

18. The image capture device of claim 12, wherein the sensor includes an interface for a command protocol that is used to generate the variable resolution depth representation.

19. The image capture device of claim 12, wherein the image capture device is a camera, stereo camera, time of flight sensor, depth sensor, structured light camera, or any combinations thereof.

20. A computing device, comprising:
a central processing unit (CPU) that is configured to execute stored instructions;
a storage device that stores instructions, the storage device comprising processor executable code that, when executed by the CPU, is configured to:
determine a depth indicator;
vary a depth information of an image based on the depth indicator; and
generate the variable resolution depth representation.

21. The computing device of claim 20, wherein the depth indicator is lighting, texture, edges, contours, colors, motion, time, or any combination thereof.

22. The computing device of claim 20, wherein varying a depth information of an image based on the depth indicator includes varying the depth information using variable bit depth, variable spatial resolution, a reduction in pixel size, or any combination thereof.

23. The computing device of claim 20, comprising obtaining one or more depth layers from the varied depth information, wherein each depth layer includes a specific depth resolution.

24. A tangible, non-transitory, computer-readable medium comprising code to direct a processor to:
determine a depth indicator;
vary a depth information of an image based on the depth indicator; and
generate the variable resolution depth representation.

25. The computer readable medium of claim 24, wherein the depth indicator is lighting, texture, edges, contours, colors, motion, time, or any combination thereof.

26. The computer readable medium of claim 24, wherein the depth indicator is specified by a use of the variable resolution depth representation by an application.

27. The computer readable medium of claim 24, wherein varying a depth information of an image based on the depth indicator includes varying the depth information using variable bit depth, variable spatial resolution, a reduction in pixel size, or any combination thereof.
